(19) United States
(12) Patent Application Publication
(10) Pub. No.: US 2009/0038907 A1
(43) Pub. Date: Feb. 12, 2009

(54) CANCEL PLATE

(75) Inventors: Ken YOSHIKAWA, Fukushima-shi (JP); Yoshiyuki KANZAKI, Fukushima-shi (JP); Tomoaki NISHIMURA, Fukushima-shi (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/188,693

(22) Filed: Aug. 8, 2008

(30) Foreign Application Priority Data
Aug. 10, 2007 (JP) 2007-209352

(51) Int. Cl. F16D 48/08

(52) U.S. Cl. 192/85 AA

(57) ABSTRACT

In order to prevents a crack from being generated in an end portion of stoppers (13) formed for regulating a diametrical expansion of a snap ring (2) in a cancel plate (1) due to stress concentration, the cancel plate (1) having an inner peripheral flange portion (12) locked to an inner peripheral portion at a drive side in a hydraulic clutch apparatus via the snap ring (2) is structured such that a plurality of the stoppers (13) for regulating a diametrical expansion of the snap ring (2) due to centrifugal force are formed by pressing to protrude on the inner peripheral flange portion (12), and both end portions (13b) of each of the stoppers (13) with respect to a circumferential direction of the cancel plate (1) rise up in a state of being inclined or curved with respect to the inner peripheral flange portion (12).

### BACKGROUND OF THE INVENTION

1. Field of the Invention

The present invention relates to a cancel plate which is used in a hydraulic clutch apparatus of an automatic transmission of a motor vehicle.

2. Description of the Conventional Art

FIG. 10 is a half sectional view showing a cancel plate in accordance with a conventional art together with a part of a hydraulic clutch apparatus in an automatic transmission of a motor vehicle by cutting them with a plane passing through an axis O, FIG. 11 is a one side plan view showing the cancel plate in accordance with the conventional art, and FIG. 12 is a sectional view along a line XII-XII in FIG. 11.

First, in the hydraulic clutch apparatus shown in FIG. 10, reference numeral 101 denotes a clutch cylinder having an annular operating space S and attached to a drive shaft (not shown), reference numeral 102 denotes an annular clutch piston arranged within the operating space S so as to be movable in an axial direction and defining a pressurizing chamber S1 with respect to the clutch cylinder 101, reference numeral 103 denotes a cancel plate defining a cancel hydraulic chamber S2 at an opposite side to the pressurizing chamber S1 with respect to the clutch piston 102, reference numeral 104 denotes a snap ring fitted and attached to a locking groove 101b formed in an inner peripheral portion 101a of the clutch cylinder 101 and supporting an inner peripheral portion of the cancel plate 103, reference numeral 105 denotes a return spring interposed in an appropriately compressed state between the clutch piston 102 and the cancel plate 103, and reference numeral 106 denotes a multiple disc clutch.

The clutch piston 102 is structured such that seal lips 102a and 102b are integrally adhered to inner and outer peripheries thereof. The seal lips 102a and 102b are slidably brought into close contact with the inner peripheral portion 101a and the outer peripheral portion 101c of the clutch cylinder 101 and are made of a rubber-like elastic material. The cancel plate 103 is structured such that a seal lip 103a is integrally adhered to an outer peripheral edge thereof. The seal lip 103a is slidably brought into close contact with an inner peripheral surface of an outer peripheral tube portion of the clutch piston 102 and is made of a rubber-like elastic material. Further, the inner peripheral portion 101a of the clutch cylinder 101 is provided with an oil introduction hole 100a for introducing a hydraulic pressure to the pressurizing chamber S1, and an oil introduction hole 100b for supplying a working fluid to the cancel hydraulic chamber S2.

The multiple disc clutch 106 has a structure in which a plurality of drive plates 106a and a plurality of driven plates 106b are arranged alternately in an axial direction. A plurality of drive plates 106a are locked to the clutch cylinder 101 in a circumferential direction in a state of being movable in the axial direction, and a plurality of driven plates 106b are locked to a clutch hub 107 provided at a driven shaft (not shown) side in a circumferential direction in a state of being movable in the axial direction. Further, a clutch pressing portion 102c is formed at an end portion of an outer peripheral tube portion of the clutch piston 102, and is opposed to the multiple disc clutch 106 in the axial direction.

In other words, in the hydraulic clutch apparatus shown in FIG. 10, the clutch piston 102 moves in the axial direction to the cancel hydraulic pressure chamber S2 side within the operating space S of the clutch cylinder 101 while compressing the return spring 105, by the hydraulic pressure of the working fluid (ATF) being applied to the pressurizing chamber S1 via the oil introduction hole 100a, thereby pressing the multiple disc clutch 106 so as to frictionally engage the drive plates 106a with the driven plates 106b. Accordingly, the multiple disc clutch 106 comes to a connected state, and a drive torque of the drive shaft (not shown) is transmitted to the driven shaft (not shown) from the clutch cylinder 101 via the multiple disc clutch 106 and the clutch hub 107.

Further, if the hydraulic pressure of the pressurizing chamber S1 is released from this connected state, the clutch piston 102 is returned to the pressurizing chamber S1 side on the basis of an expansion force of the compressed return spring 105 so as to cancel a frictional engagement state between the drive plates 106a and the driven plates 106b in the multiple disc clutch 106, thereby interrupting the driving force transmission from the drive shaft to the driven shaft.

In this case, since the clutch cylinder 101 and the clutch piston 102 are rotated around the axis O together with the drive shaft, the working fluid introduced into the pressurizing chamber S1 is pressed to the outer peripheral side on the basis of centrifugal force. Accordingly, hydraulic pressure caused by the centrifugal force mentioned above (hereinafter, referred to as centrifugal hydraulic pressure) is generated within the pressurizing chamber S1, and the centrifugal hydraulic pressure is applied in such a manner as to prevent the returning motion of the clutch piston 102 by the return spring 105. However, since centrifugal hydraulic pressure (cancel hydraulic pressure) which almost balances with the centrifugal hydraulic pressure of the pressurizing chamber S1 is generated in the working fluid reserved in the cancel hydraulic pressure chamber S2 defined between the clutch piston 102 and the cancel plate 103, it is possible to smoothly disconnect the clutch on the basis of the returning motion of the clutch piston 102.

Further, since the snap ring 104 is formed in an approximately C-shape having a cut at one position in the circumferential direction, there is a risk that the snap ring 104 falls away from the locking groove 101b of the clutch cylinder 101 if it is deformed so as to expand its diameter on the basis of centrifugal force at a time of rotating at a high-speed. Accordingly, in order to regulate the expanding deformation of the snap ring 104 as mentioned above, an inner peripheral portion of the cancel plate 103 is provided in a protruding manner with a plurality of stoppers 103b which surround an outer periphery of the snap ring 104, on a surface at an opposite side to the cancel hydraulic pressure chamber S2. Further, the stoppers 103b are formed by pressing to protrude in a rod shape as shown in FIGS. 11 and 12 (refer, for example, to Japanese Patent No. 3308204).

However, in accordance with the conventional cancel plate 103 mentioned above, if centrifugal hydraulic pressure (the cancel hydraulic pressure) generated in the cancel hydraulic pressure chamber S2 is repeatedly applied, there is a risk that a crack is generated in both end edge portions 103c of the stopper 103 due to fatigue. This is because both the end edge portions 103c of the stopper 103b rise up approximately at right angles so that stress tends to concentrate there and, in addition, strength of those portions becomes small due to a shear caused at a time of being pressed to protrude with a convex mold and a concave mold (not shown). Further, once a crack is generated, it becomes a starting point for the crack to grow until breakage of the cancel plate 103 is caused, whereby there is a risk that the automatic transmission is broken.

### SUMMARY OF THE INVENTION

### Problem to be Solved by the Invention

The present invention is made by taking the point mentioned above into consideration, and a technical object of the present invention is to prevent a crack from being generated in end portions of stoppers formed for regulating a diametrical expansion of a snap ring on a cancel plate due to a stress concentration.

### Means for Solving the Problem

As a means for effectively achieving the technical object mentioned above, in accordance with the present invention, there is provided a cancel plate having an inner peripheral flange portion locked to an inner peripheral portion at a drive side in a hydraulic clutch apparatus via a snap ring, wherein a plurality of stoppers for regulating a diametrical expansion of the snap ring due to centrifugal force are formed by pressing to protrude on the inner peripheral flange portion, and both end portions of each of the stoppers with respect to a circumferential direction of the cancel plate rise up in a state of being inclined or curved with respect to the inner peripheral flange portion.

### EFFECT OF THE INVENTION

In accordance with the cancel plate on the basis of the present invention, since both the ends of the stopper for regulating a diametrical expansion of the snap ring rise up in a state of being inclined or curved with respect to the inner peripheral flange portion, stress does not concentrate into both the ends of the stopper even if the cancel plate receives deforming force caused by centrifugal hydraulic pressure or the like. Accordingly, it is possible to effectively prevent a crack generated due to fatigue, and breakage caused thereby.

### BRIEF EXPLANATION OF DRAWINGS

FIG. 1 is a one side plan view showing a first embodiment of a cancel plate in accordance with the present invention;

FIG. 2 is a sectional view along a line O-II in FIG. 1;

FIG. 3 is a sectional view along a line III-III in FIG. 1;

FIGS. 4(A) to 4(C) are perspective views showing examples of shapes of a stopper in accordance with the first embodiment;

FIG. 5 is a one side plan view showing a second embodiment of the cancel plate in accordance with the present invention;

FIG. 6 is a sectional view along a line O-VI in FIG. 5;

FIGS. 7(A) to 7(C) are perspective views showing examples of shapes of a stopper 13 in accordance with the second embodiment;

FIG. 8 is a plan view showing another embodiment in which an extending direction of the stopper 13 is changed;

FIG. 9 is a plan view showing another embodiment in which the extending direction of the stopper 13 is changed;

FIG. 10 is a half sectional view showing a cancel plate in accordance with a conventional art together with a part of a hydraulic clutch apparatus, by cutting them with a plane passing through an axis O;

FIG. 11 is a one side plan view showing a cancel plate in accordance with the conventional art; and

FIG. 12 is a sectional view along a line XII-XII in FIG. 11.

### DETAILED DESCRIPTION OF PREFERRED EMBODIMENT

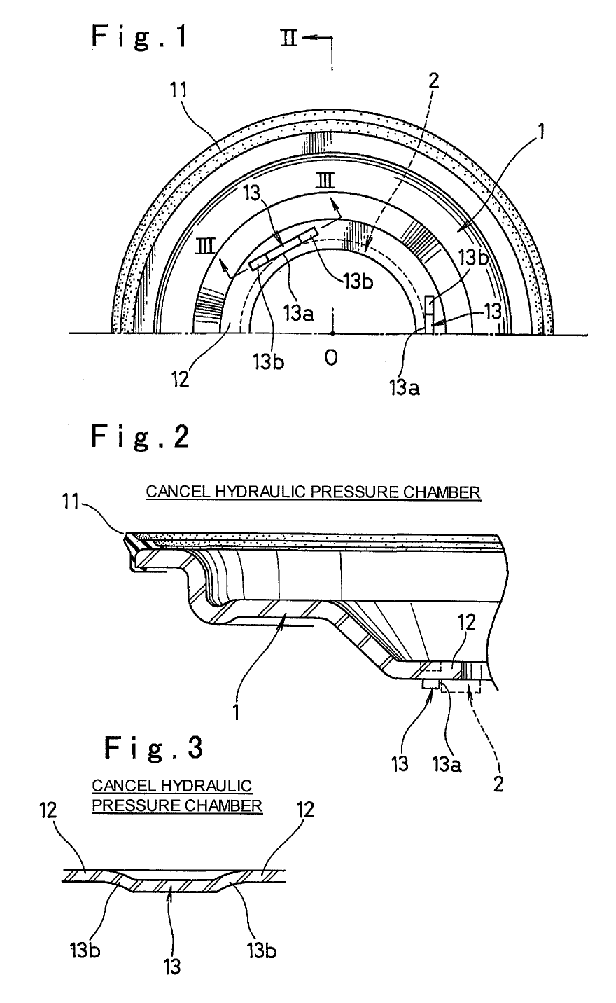

A description will be given below of preferable embodiments in accordance with the present invention with reference to the accompanying drawings. FIG. 1 is a one side plan view showing a first embodiment of a cancel plate in accordance with the present invention, FIG. 2 is a sectional view along a line O-II in FIG. 1, and FIG. 3 is a sectional view along a line III-III in FIG. 1.

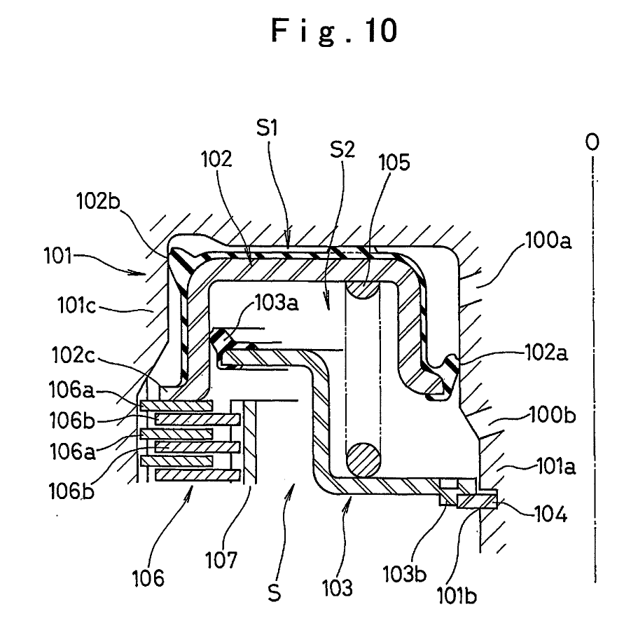

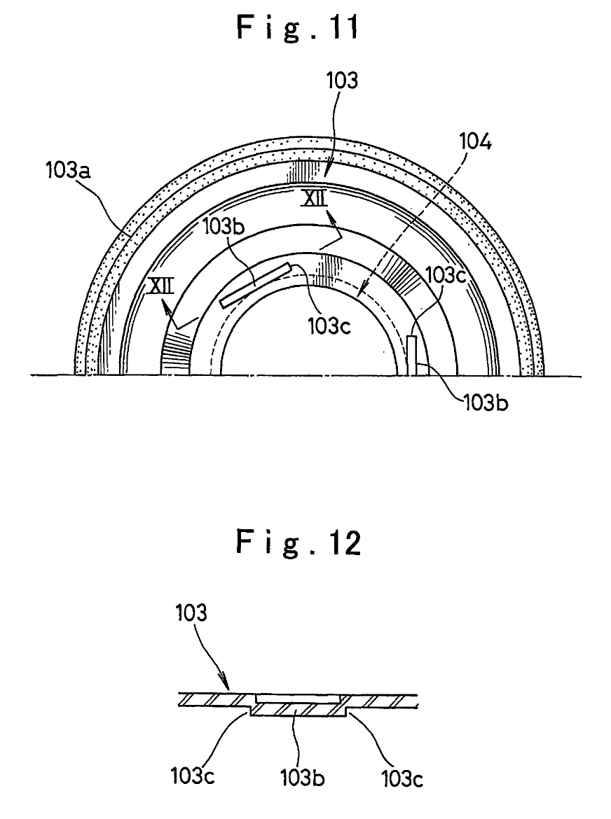

A cancel plate 1 shown in FIGS. 1 and 2 is used in a hydraulic clutch apparatus in the same manner as the conventional one, and since the hydraulic clutch apparatus is the same as the conventional one previously described with reference to FIG. 10, a description thereof will be omitted. In this case, an upper side corresponds to a cancel hydraulic pressure chamber side in FIGS. 2 and 3.

The cancel plate 1 is manufactured by punching press forming of a metal plate or the like, and a seal lip 11 is integrally adhered to an outer peripheral portion thereof. The seal lip 11 is slidably brought into close contact with an inner peripheral surface of an outer peripheral tube portion of a clutch piston (reference numeral 102 in FIG. 10) (not shown) and is made of a rubber-like elastic material. The seal lip 11 is adhered through vulcanization to the cancel plate 1 at the same time of vulcanization molding, by the steps of setting the cancel plate 1 to which a vulcanization adhesive agent is previously applied, within a predetermined metal mold for rubber vulcanization molding, filling an unvulcanized rubber material within an annular cavity defined between the cancel plate 1 and an inner surface of the metal mold in accordance with a mold clamping, and heating and pressurizing them.

An inner peripheral flange portion 12 of the cancel plate 1 is provided with stoppers 13 for regulating a diametrical expanding deformation of the snap ring 2 supporting the cancel plate 1 due to centrifugal force at an interval of 120 degree, for example, in a circumferential direction. The stopper 13 is formed by pressing to protrude toward an opposite side to a cancel hydraulic pressure chamber side from the inner peripheral flange portion 12 forming a plane orthogonal to an axis, and, as shown in FIG. 1, extends in a tangential direction with respect to an outer peripheral surface of the snap ring 2. As shown in FIG. 2, a surface coming into contact with the snap ring 2, that is, a surface 13a directed to an inner peripheral side of the cancel plate 1 rises up approximately vertically with respect to the inner peripheral flange portion 12, and both end portions 13b with respect to the circumferential direction of the cancel plate 1 rise up in a state of being inclined or curved with respect to the inner peripheral flange portion 12.

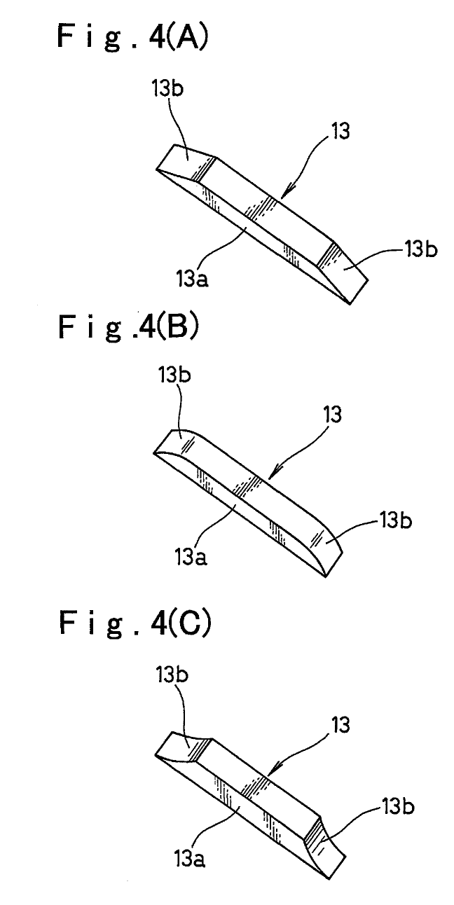

FIGS. 4(A) to 4(C) are perspective views showing examples of shapes of the stopper 13 in accordance with the first embodiment. An example shown in FIG. 4(A) is structured such that both the end portions 13b of the stopper 13 are formed as inclined surfaces, an example shown in FIG. 4(B) is structured such that both the end portions 13b of the stopper 13 are formed as curved convex surfaces, and an example shown in FIG. 4(C) is structured such that both the end portions 13b of the stopper 13 are formed as curved concave surfaces.

In accordance with the cancel plate 1 in accordance with the first embodiment having the structure mentioned above, even if centrifugal hydraulic pressure generated in the cancel hydraulic pressure chamber is applied, deforming stress thereby does not concentrate to both the end portions 13b of the stopper 13. This is because both the end portions 13b gently rise up in the state of being inclined or curved with respect to the inner peripheral flange portion 12 of the cancel plate 1. Further, since both the end portions 13b do not suffer from a shear between the convex mold and the concave mold at a time of press molding, strength is not deteriorated. Accordingly, it is possible to prevent a crack from being generated by fatigue of both the end portions 13b and to prevent the cancel plate 1 from being broken due to the crack, and it is further possible to prevent the automatic transmission from being broken consequently.

In this case, in order to prevent one end of the snap ring 2 from being caught by the end portion 13b of the stopper 13 so as to run onto it even if a relative rotation between the cancel plate 1 and the snap ring 2 occurs, it is preferable to apply rounded chamfers to corners at an inner peripheral side of both the end portions 13b.

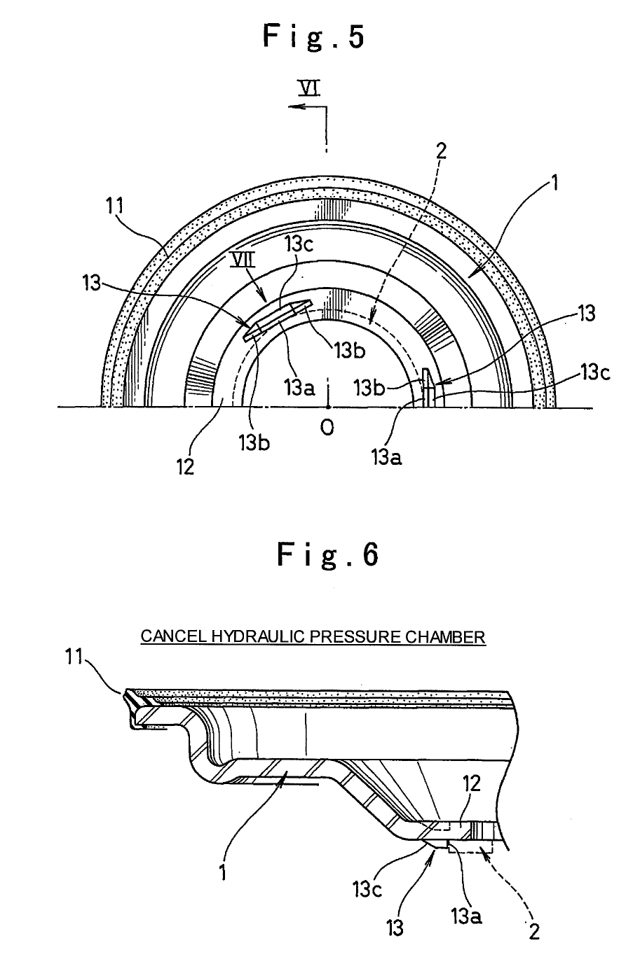

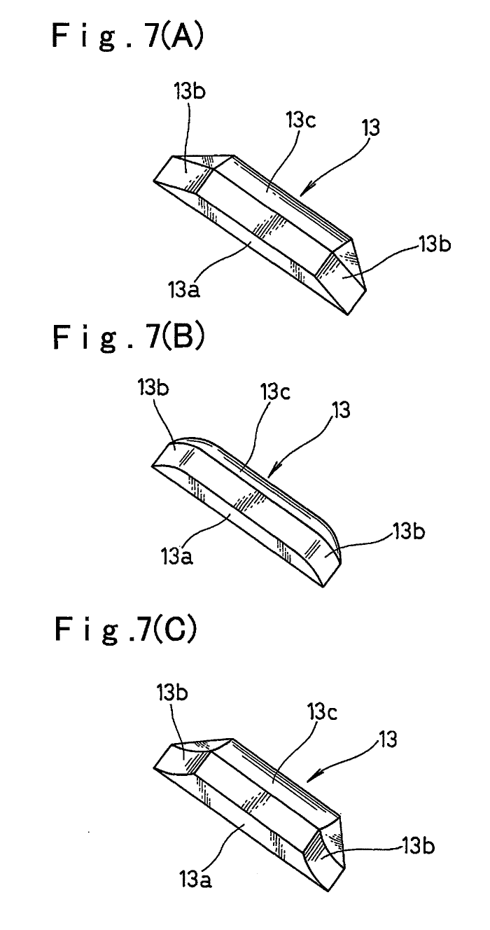

Next, FIG. 5 is a one side plan view showing a second embodiment of the cancel plate in accordance with the present invention, FIG. 6 is a sectional view along a line O-VI in FIG. 5, and FIGS. 7(A) to 7(C) are perspective views showing examples of shapes of a stopper 13 in accordance with the second embodiment.

In this cancel plate 1, a different point from the first embodiment exists in a shape of the stopper 13. In particular, the stopper 13 is structured such that a surface 13c directed to an outer peripheral side of the cancel plate 1 rises up in a state of being inclined or curved with respect to the inner peripheral flange portion 12 forming a plane orthogonal to the axis, in the second embodiment.

Further, in a structure in which both the end portions 13b of the stopper 13 are formed as inclined surfaces as an example shown in FIG. 7(A), the surface 13c directed to an outer peripheral side is formed also as an inclined surface. In a structure in which both the end portions 13b of the stopper 13 are formed as curved convex surfaces, as an example shown in FIG. 7(B), the surface 13c directed to the outer peripheral side is formed also as a curved convex surface. In a structure in which both the end portions 13b of the stopper 13 are formed as curved concave surfaces, as an example shown in FIG. 7(C), the surface 13c directed to the outer peripheral side is formed also as a curved concave surface.

In accordance with the cancel plate 1 of the second embodiment having the structure mentioned above, even if centrifugal hydraulic pressure generated in the cancel hydraulic pressure chamber is applied, deforming stress thereby does not concentrate into not only both the end portions 13b of the stopper 13 but also the surface 13c directed to the outer peripheral side. Further, since the surface 13c directed to the outer peripheral side does not suffer form a shear at a time of press molding as well as both the end portions 13b, strength is not deteriorated. Accordingly, the strength of the cancel plate 1 is further improved, and it is possible to prevent the generation of a crack due to fatigue, breakage of the cancel plate 1 caused thereby and, consequently, the breakage of the automatic transmission.

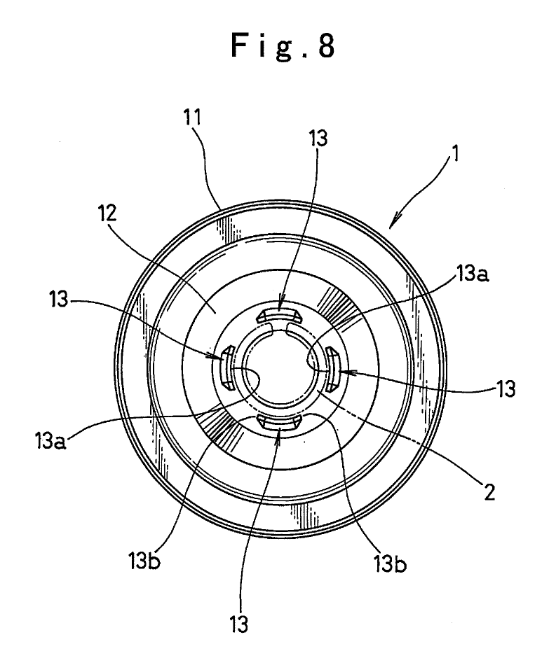

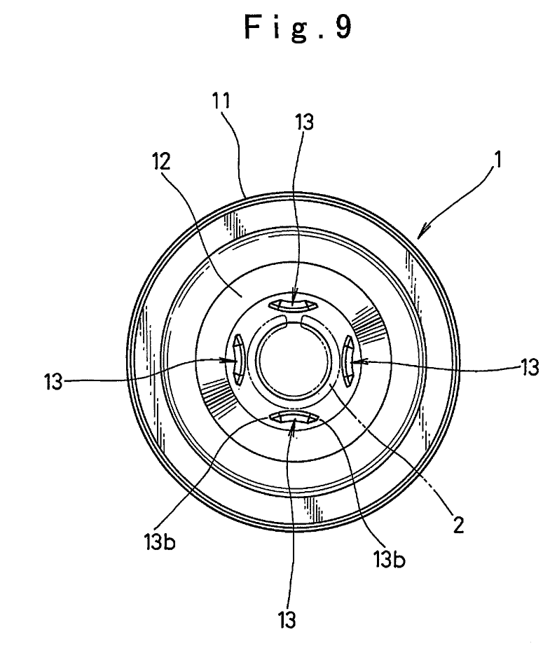

In this case, in the embodiment mentioned above, the stopper 13 extends in the tangential direction with respect to the outer peripheral surface of the snap ring 2, however, the structure is not limited to this. FIGS. 8 and 9 are plan views showing other embodiments in which the extending direction of the stopper 13 is changed.

Among them, the embodiment shown in FIG. 8 is structured such that the stopper 13 extends in a circular arc shape corresponding to the outer peripheral surface of the snap ring 2. In this case, since a contact area of the surface 13a directed to the inner peripheral side of the cancel plate 1 with the snap ring 2 becomes larger, it is possible to firmly support the snap ring 2. Further, in order to prevent one end of the snap ring 2 from being caught by the end portion 13b of the stopper 13 so as to run onto it, even if a relative rotation between the cancel plate 1 and the snap ring 2 occurs, it is preferable to apply rounded chamfers to corners at the inner peripheral side of both the end portions 13b.

On the other hand, the embodiment shown in FIG. 9 is structured such that the stopper 13 extends in a circular arc shape being convex toward the outer peripheral surface of the snap ring 2 (toward the inner peripheral side of the cancel plate 1). Accordingly, even if the relative rotation between the cancel plate and the snap ring 2 occurs, it is possible to securely prevent one end of the snap ring 2 from being caught by the end portion 13b of the stopper 13 so as to run onto it.

What is claimed is:

1. A cancel plate having an inner peripheral flange portion locked to an inner peripheral portion at a drive side in a hydraulic clutch apparatus via a snap ring, wherein a plurality of stoppers for regulating a diametrical expansion of said snap ring due to a centrifugal force are formed by pressing to protrude on said inner peripheral flange portion, and both end portions of each of the stoppers with respect to a circumferential direction of the cancel plate rise up in a state of being inclined or curved with respect to said inner peripheral flange portion.
